(19) United States
(12) Patent Application Publication
(10) Pub. No.: US 2026/0285043 A1
(43) Pub. Date: Sep. 24, 2026

(54) LIQUID DISCHARGE HEAD AND LIQUID DISCHARGE APPARATUS

(71) Applicant: Naoya ARITA, Tokyo (JP)

(72) Inventor: Naoya ARITA, Tokyo (JP)

(21) Appl. No.: 19/558,532

(22) Filed: Mar. 6, 2026

(30) Foreign Application Priority Data
Mar. 21, 2025 (JP) 2025-046590

(51) Int. Cl. B41J 2/14

(52) U.S. Cl. CPC B41J 2/1433; B41J 2/14233; B41J 2002/14475

(57) ABSTRACT

A liquid discharge head includes a pressure chamber and a nozzle plate. The pressure chamber stores liquid. The nozzle plate has a nozzle communicating with the pressure chamber. The nozzle plate includes an actuator in the nozzle plate to displace the nozzle plate to discharge the liquid in the pressure chamber from the nozzle in a discharge direction. The nozzle plate also has an outlet having a first cross-sectional area in a plane orthogonal to the discharge direction; an inlet having a second cross-sectional area in the plane; and an intermediate portion between the outlet and the inlet in the discharge direction. The intermediate portion has a maximum cross-sectional area larger than the first cross-sectional area of the outlet and the second cross-sectional area of the inlet in the plane.

### CROSS-REFERENCE TO RELATED APPLICATION

This patent application is based on and claims priority pursuant to 35 U.S.C. § 119 (a) to Japanese Patent Application No. 2025-046590, filed on Mar. 21, 2025, in the Japan Patent Office, the entire disclosure of which is hereby incorporated by reference herein.

### BACKGROUND

### Technical Field

The present disclosure relates to a liquid discharge head and a liquid discharge apparatus.

### Related Art

There has been developed a liquid discharge head including a nozzle that discharges liquid, a pressure chamber that is in communication with the nozzle, and an actuator that causes fluctuation of pressure to occur in the pressure chamber, the liquid discharge head driving the actuator to discharge the liquid in the pressure chamber from an outlet of the nozzle.

### SUMMARY

The present disclosure described herein provides a liquid discharge head including a pressure chamber and a nozzle plate. The pressure chamber stores liquid. The nozzle plate has a nozzle communicating with the pressure chamber. The nozzle plate includes an actuator in the nozzle plate to displace the nozzle plate to discharge the liquid in the pressure chamber from the nozzle in a discharge direction. The nozzle plate also has an outlet having a first cross-sectional area in a plane orthogonal to the discharge direction; an inlet having a second cross-sectional area in the plane; and an intermediate portion between the outlet and the inlet in the discharge direction. The intermediate portion has a maximum cross-sectional area larger than the first cross-sectional area of the outlet and the second cross-sectional area of the inlet in the plane.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a cross-sectional view schematically illustrating a nozzle-plate-vibration type liquid discharge head according to an embodiment;

FIG. 2 is a perspective view schematically illustrating a nozzle surface of the liquid discharge head;

FIG. 3 is an enlarged cross-sectional view of a portion surrounded by a broken line indicated by a reference sign X in FIG. 1;

FIG. 4 is a plan view schematically illustrating an internal structure of the liquid discharge head, and is a cross-sectional view taken along a line C-C′;

FIG. 5 is a front view schematically illustrating the internal structure of the liquid discharge head, and is a cross-sectional view taken along a line A-A′;

FIG. 6 is a side view schematically illustrating the internal structure of the liquid discharge head, and is a cross-sectional view taken along a line B-B′;

FIG. 7 is an explanatory view schematically illustrating a cross section of a nozzle according to the embodiment, which is taken in a liquid discharging direction;

FIG. 8 is a view illustrating, in the nozzle according to the present embodiment, a relationship between a distance from the nozzle surface in a liquid discharging direction Z and a cross-sectional diameter inside the nozzle;

FIG. 9A is a view illustrating a thickness of the nozzle plate of the nozzle-plate-vibration type liquid discharge head according to the present embodiment;

FIG. 9B is a view illustrating a thickness of a nozzle plate of an ordinary liquid discharge head;

FIG. 10A is an explanatory view of a meniscus in the nozzle-plate-vibration type liquid discharge head according to the present embodiment;

FIG. 10B is an explanatory view of a meniscus in an ordinary liquid discharge head;

FIG. 11A is an explanatory view of a nozzle shape and the meniscus in the nozzle-plate-vibration type liquid discharge head according to the present embodiment;

FIG. 11B is an explanatory view of a nozzle shape and a meniscus in an ordinary liquid discharge head;

FIG. 12 is an explanatory view schematically illustrating a cross section of a nozzle in a liquid discharge head according to a modification, the cross section being taken in the liquid discharging direction;

FIG. 13 is an explanatory view schematically illustrating a cross section of a nozzle in a liquid discharge head according to a modification, the cross section being taken in the liquid discharging direction;

FIG. 14 is an outline explanatory view of a printer according to the embodiment;

FIG. 15 is a plan explanatory view of an example of a head unit of the printer;

FIG. 16 is a plan explanatory view of a main portion of the printer;

FIG. 17 is a side explanatory view of the main portion of the printer according to a present example;

FIG. 18 is a plan explanatory view of the main portion of a liquid discharge unit according to the present example; and

FIG. 19 is a front explanatory view of the liquid discharge unit according to the present example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to the present invention, air bubbles are less likely to remain in a pressure chamber, making it possible to easily acquire stable discharging performance.

A description is given below of one embodiment in which the present invention is applied to a liquid discharge head installed in a liquid discharge apparatus.

Note that the present invention is not to be considered limited to the following embodiment but can be changed within the range that can be conceived of by those skilled in the art, such as other embodiments, additions, modifications, and deletions, and the scope of the present invention encompasses any aspect, as long as the aspect achieves the operation and advantageous effect of the present invention.

The liquid discharge head according to the present embodiment is a nozzle-plate-vibration type liquid discharge head that discharges liquid in a pressure chamber from a nozzle by varying pressure in the pressure chamber by an actuator provided on a nozzle plate having the nozzle. The nozzle-plate-vibration type is characterized in that droplets can be splashed with a small force, compared with an ordinary unimorph piezo head (that discharges liquid by vibrating a surface facing a wall portion (a nozzle communication wall) of the pressure chamber, which has a communication port that is in communication with the nozzle), and can achieve power saving of the actuator. However, the present invention is not limited to the nozzle-plate-vibration type liquid discharge head, and is also applicable to an ordinary unimorph piezo head.

When a nozzle density is increased, a space for laying out wires for voltage application is limited, and thus, it is difficult to install wires on a substrate surface. By constructing the wires and a drive circuit in the substrate, the wires can be laid out even in a configuration having a high nozzle density. In general, a lead zirconate titanate (PZT) is widely used as a material of a piezoelectric body used as an actuator because of its high piezoelectric characteristics. However, when a piezoelectric film is formed on a substrate on which wires and a drive circuit are constructed, a PZT film formation/crystallization temperature has to be 600° C. or higher. Therefore, when PZT is used as a material of a piezoelectric body, the drive circuit in the substrate and the wires thereof cannot withstand high temperatures. In the configuration in which the wires and the drive circuit are constructed in the substrate, a piezoelectric material having a lower film formation temperature than PZT has to be used as the piezoelectric material, and a material having lower piezoelectric characteristics than PZT is necessarily selected. However, since the nozzle-plate-vibration type described above has a feature that droplets can be splashed with a smaller force than an ordinary unimorph piezo head, it is possible to discharge the liquid satisfactorily even when a material having lower piezoelectric characteristics than PZT is selected. Even a piezoelectric material such as a non-lead material having a low film formation/crystallization temperature but low power can discharge the liquid satisfactorily. It is possible to construct wires and a drive circuit in a substrate, making it possible to implement a highly dense configuration. Since the nozzle-plate-vibration type can reduce a volume of the pressure chamber, the liquid discharge head can be downsized.

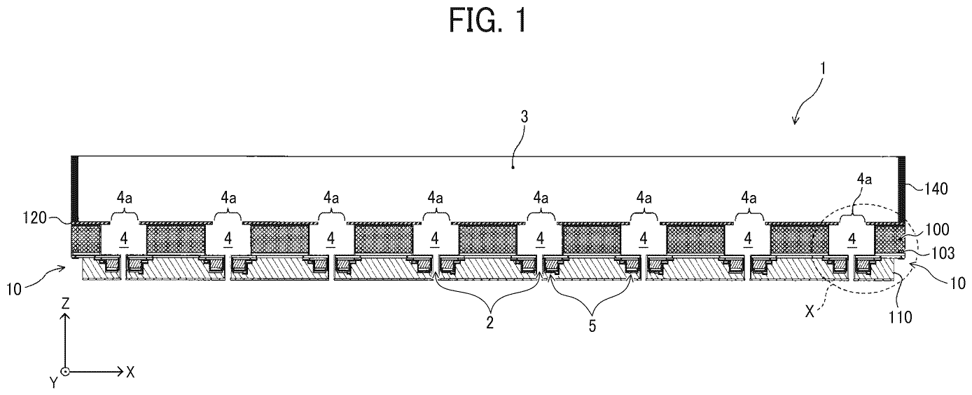

FIG. 1 is a cross-sectional view schematically illustrating a nozzle-plate-vibration type liquid discharge head according to the present embodiment.

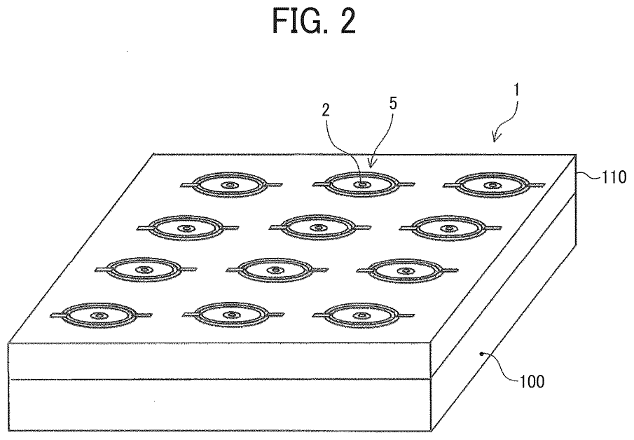

FIG. 2 is a perspective view schematically illustrating a nozzle surface of the liquid discharge head according to the present embodiment.

A liquid discharge head 1 includes a nozzle plate 110, a pressure chamber substrate 100, and a fluid resistance substrate 120. The liquid discharge head 1 further includes a frame 140, and the like as will be described later.

The nozzle plate 110 has a thin film shape and includes multiple nozzles 2 for discharging liquid and piezoelectric body elements 5 serving as electromechanical transducer elements that are annular actuators respectively disposed around the nozzles 2. The pressure chamber substrate 100 includes multiple pressure chambers (also referred to as individual liquid chambers, individual flow channels, and pressurization liquid chambers, for example) 4 that are respectively in communication with the multiple nozzles 2. Each of the nozzles 2 (a vibration film 103) is provided on one surface of each of the pressure chambers 4, and, on a side facing the one surface, the fluid resistance substrate 120 and openings 4a are disposed. The frame 140 includes a common liquid chamber 3 that is in communication with the multiple pressure chambers 4 respectively via the openings 4a. An electrical coupling pad 55 for coupling to electrical components such as an external power supply is provided at both ends of the liquid discharge head 1.

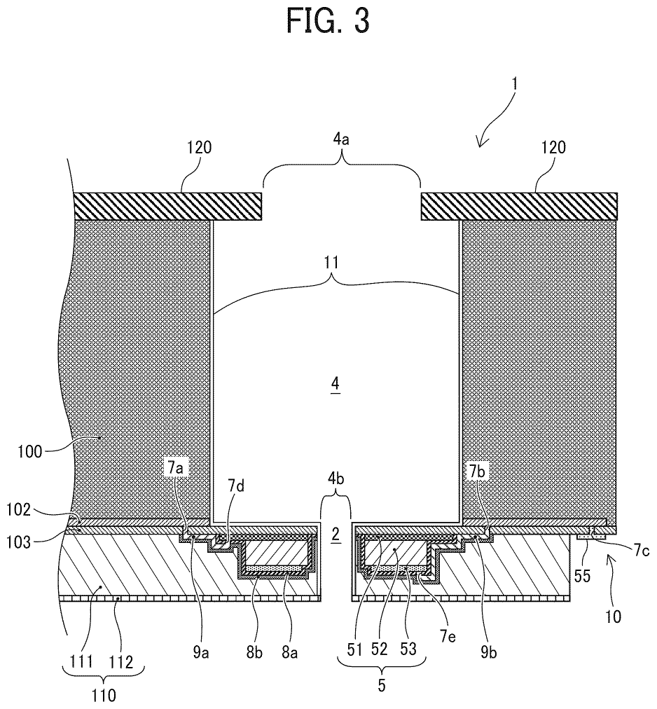

FIG. 3 is an enlarged cross-sectional view of a portion surrounded by a broken line indicated by a reference sign X in FIG. 1.

The pressure chamber substrate 100 is a silicon-on-insulator (SOI) substrate, and includes a wiring portion 102 on a side where the vibration film 103 is film-formed. A drive circuit to which the wiring portion 102 is coupled is a circuit including a transistor and a resistor, for example. The wiring portion 102 includes a wiring portion coupled to a first electrode 51 (also referred to as a common electrode) and a wiring portion for applying a drive voltage (drive waveform) to a second electrode 53 (also referred to as an individual electrode). The wiring portion 102 is electrically coupled to the electrical coupling pad 55 via a third contact 7c that opens on the vibration film 103.

The nozzle plate 110 includes a nozzle formation portion (film) 111 that covers the piezoelectric body elements 5. The multiple nozzles 2 are formed in the nozzle formation portion 111. A liquid-repellent film 112 is formed on a nozzle surface of the nozzle formation portion 111. In a case where the liquid is continuously discharged, mist generated simultaneously with discharging of the liquid adheres to the nozzle surface. When the mist adheres to the nozzle surface at a large amount, there is a possibility that the liquid discharged from each of the nozzles 2 is negatively influenced by the liquid having adhered to the nozzle surface, and deviates from a desired position where liquid is to be applied. By forming the liquid-repellent film 112 on the nozzle surface, adhesion of the liquid to the nozzle surface can be suppressed, and a negative influence of liquid adhered to the nozzle surface on the liquid discharged from each of the nozzles 2 can be suppressed.

Each of the piezoelectric body elements 5 on the nozzle plate 110 includes the first electrode 51, a piezoelectric film 52, and the second electrode 53. The piezoelectric body element 5 is covered with a first insulating film 8a. The first insulating film 8a is formed with a hole-shaped fourth contact 7d for making electrical coupling to the first electrode 51 and a hole-shaped fifth contact 7e for making electrical coupling to the second electrode 53.

The first insulating film 8a is formed with a first lead wire 9a that electrically couples the first electrode 51 of the piezoelectric body element 5 and the wiring portion 102 of the pressure chamber substrate 100 and a second lead wire 9b that electrically couples the second electrode 53 of the piezoelectric body element 5 and the wiring portion 102 of the pressure chamber substrate 100.

The first lead wire 9a is electrode-like coupled to the first electrode 51 via the fourth contact 7d and electrode-like coupled to the wiring portion 102 via a first contact 7a. The second lead wire 9b is electrode-like coupled to the second electrode 53 via the fifth contact 7e and electrode-like coupled to the wiring portion 102 via a second contact 7b. The first lead wire 9a and the second lead wire 9b are covered with a second insulating film 8b. In the present embodiment, the second insulating film 8b further covers the piezoelectric body element 5. The second insulating film 8b has a function of preventing moisture having entered the nozzle formation portion 111 made of a resin from entering the piezoelectric body element 5 to protect the piezoelectric body element 5.

A lead wiring portion may be provided to each of the first electrode 51 and the second electrode 53, and may be directly electrode-like coupled to the wiring portion 102 via a contact that opens on the vibration film. An adhesion-improvement film for securing adhesion to the nozzle formation portion 111 may be formed on the second insulating film 8b.

The liquid having filled the liquid discharge head 1 enters each of the nozzles 2 and forms a meniscus in the nozzle. By applying a predetermined drive voltage to each of the electrode 51 and the electrode 53 of each of the piezoelectric body elements 5, the piezoelectric film 52 displaces (vibrates), and the vibration film 103 vibrates in upper and lower directions in FIG. 3. As the vibration film 103 vibrates, a pressure change occurs in the liquid in the pressure chamber to cause the liquid to be discharged from the nozzle 2.

In the liquid discharge head 1 according to the present embodiment, a protective film 11 serving as a surface layer that has a lyophilic property to the liquid that the liquid discharge head 1 discharges and that prevents erosion by the liquid is formed on an inner peripheral surface of each of the nozzles 2, an inner peripheral surface of each of the pressure chambers 4, and a bottom surface of the common liquid chamber 3. In the present embodiment, the liquid that the liquid discharge head 1 discharges is alkaline, and the pressure chamber substrate 100 and the vibration film 103 forming the pressure chambers 4 are made of silicon single crystal and silicon oxide. These materials are vulnerable to alkaline liquids, and elute into and eroded by alkaline solutions. To prevent such an event, forming the protective film 11 having a liquid resistance property for preventing erosion by the liquid makes it possible to protect the pressure chamber substrate 100 and the vibration film 103 from the liquid.

The pressure chambers 4 and the nozzles 2 are formed through dry etching. When a dry etching gas contains fluorine, a surface film containing fluorine is formed on an inner wall surface of each of the pressure chambers 4 and the inner peripheral surface of each of the nozzles 2 after having undergone etching, and the inner wall surface of each of the pressure chambers 4 and the nozzle inner peripheral surface acquire a liquid-repellent property. If the inner peripheral surface of each of the pressure chambers 4 has acquired a liquid-repellent property, the liquid does not fully wet-spread on the inner peripheral surface of each of the pressure chambers 4 during filling of the liquid. Therefore, each of the pressure chambers 4 may not be satisfactorily filled with the liquid, and air bubbles may be generated at corner portions or the like in each of the pressure chambers 4.

In the present embodiment, since the protective film 11 having a lyophilic property is formed on the inner peripheral surface of each of the pressure chambers 4 and the inner peripheral surface of each of the nozzles 2, it is possible to improve wettability of the liquid to the inner peripheral surface of each of the pressure chambers 4 and the nozzles 2. The protective film 11 merely has to have a higher lyophilic property to the liquid than a lyophilic property of a film formation surface of each of the pressure chambers 4 and the nozzles 2 (a lower layer surface of the protective film 11) on which the protective film 11 is formed. Using a protective film having a high hydrophilic property in a case where a solvent of the liquid is aqueous or using a protective film having a high oleophilic property in a case where a solvent of the liquid is oily makes it possible to form the protective film 11 having a high lipophilic property.

As described above, by forming the protective film 11 having a lyophilic property to the liquid filled in each of the pressure chambers 4 on the inner peripheral surface of each of the nozzles 2 and the pressure chambers 4, the liquid easily wets and spreads on the inner peripheral surface of each of the pressure chambers 4 and the nozzles 2 during filling of the liquid. As a result, it is possible to improve ease of filling of the liquid. Thus, it is possible to favorably fill each of the pressure chambers 4 and the nozzles 2 with the liquid without performing pressurization or suction during liquid filling. It is possible to suppress occurrence of cracks in the vibration film 103 during filling of the liquid.

Since a solvent of the liquid in the present embodiment is aqueous, forming the protective film 11 that does not contain at least fluorine on the inner peripheral surface of each of the pressure chambers 4 and the nozzles 2 makes it possible to improve the lipophilic property, compared with a surface film that contains fluorine, which is formed through dry etching. In addition to the features described above, since this film comes into direct contact with various liquids, it is desirable to use a material having a liquid resistance property, for example, a metal oxide forming a passivation state. As a method for improving the lipophilic property, it is also possible to use a mixture of a metal oxide forming the passivation state with silicon dioxide (SiO₂) at a molecular level. As a result of substitution for O on its surface, SiO₂ in the protective film 11 includes an OH group having a hydrophilic property. It is possible to impart a further higher hydrophilic property to the protective film 11. Examples of the metal of the metal oxide include tantalum (Ta), niobium (Nb), titanium (Ti), zirconium (Zr), hafnium (Hf), and tungsten (W) having high correspondence to the number of oxides. In particular, Zr or Hf having a valence similar to that of SiO₂, or Ta having a valence before or after that is particularly desirable.

For example, the protective film 11 may have a two-layer structure of a film having a liquid resistance property and a film having a lipophilic property. In this case, a film having a liquid resistance property is formed on the inner peripheral surface of each of the nozzles 2 and the pressure chambers 4, and then a film having a lipophilic property is formed on the film having the liquid resistance property.

Although, in the present embodiment, the protective film 11 having the lipophilic property is also formed on the surface of the pressure chamber substrate 100, which forms the bottom surface of the common liquid chamber 3 and which is present on a side opposite to the film formation surface of the vibration film 103, the protective film 11 on this surface may have merely a liquid resistance property. However, a step of forming the protective film 11 on the bottom surface of the common liquid chamber 3 has to be provided separately from a step of forming a protective film having a lipophilic property on the nozzle inner peripheral surface and a wall surface of each of the pressure chambers, possibly increasing manufacturing steps in number. The protective film 11 being formed on the bottom surface of the common liquid chamber 3 allows the liquid to easily wet and spread on the bottom surface of the common liquid chamber 3, further improving the ease of filling of the liquid. It is preferable to form the protective film 11 having the lipophilic property also on the surface of the pressure chamber substrate 100, which forms the bottom surface of the common liquid chamber 3 and which is present on the side opposite to the film formation surface of the vibration film 103.

The vibration film 103 may be made of at least a material having an insulation property such as SiO₂, SiN, a metal oxide, or a resin. However, to increase a displacement, a material having a low Young's modulus is desirable, and SiO₂ (silicon dioxide) having a relatively small difference in linear expansion coefficient from the pressure chamber substrate 100, when the difference is taken into account, is most desirable as the material of the vibration film 103.

A first electrode layer 151 and a second electrode layer 153 are desirably made of a metal having low electric resistance and a low reactivity, and are desirably made of a metal such as Ir or Mo. As a piezoelectric material forming a piezoelectric layer 152, when the wiring portion 102 is incorporated in the pressure chamber substrate 100 for improvement in density, similar to the present embodiment, a piezoelectric material having a film formation temperature of 450° C. or lower is desirable for preventing breakage. Examples of the piezoelectric material having a film formation temperature of 450° C. or lower include AlN or ScAlN having a piezoelectric constant higher than that of AlN.

Using ScAlN as the piezoelectric material makes it also possible to acquire advantages described below. In other words, although it is possible to improve the piezoelectric characteristics by aligning a crystal orientation in the piezoelectric film 52, it is necessary to provide an orientation control layer between the vibration film 103 and the first electrode 51 for controlling the orientation. When the piezoelectric material of the piezoelectric film 52 is ScAlN, using ScAlN also as an orientation control layer makes it possible to make a lattice constant of the first electrode 51 made of Mo close to a lattice constant of ScAlN. As a result, the crystal orientation in the piezoelectric film 52 is aligned, making it possible to improve the piezoelectric characteristics.

Although, in the present embodiment, the fluid resistance substrate 120 allows fluid resistance portions that respectively narrow the openings 4a between the pressure chambers 4 and the common liquid chamber 3 to be disposed, the fluid resistance substrate 120 may not be provided and the fluid resistance portions may not be disposed. However, since, in the present embodiment, the pressure chambers are disposed close to each other in a highly dense manner, pressure generated when the liquid is discharged from one pressure chamber 4 is likely to propagate to the pressure chambers 4 that are adjacent to the one pressure chamber 4, and to negatively influence discharging of the liquid from the nozzles 2 of the pressure chambers 4 that are adjacent to the one pressure chamber 4. Disposing the fluid resistance portions as described in the present embodiment makes it possible to suppress such a negative influence.

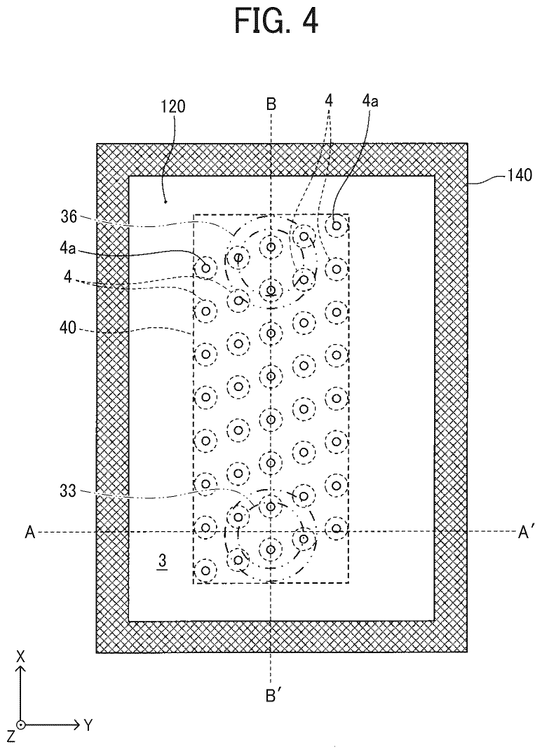

FIG. 4 is a plan view schematically illustrating an internal structure of the liquid discharge head 1 according to the present embodiment, and is a cross-sectional view taken along a line C-C′.

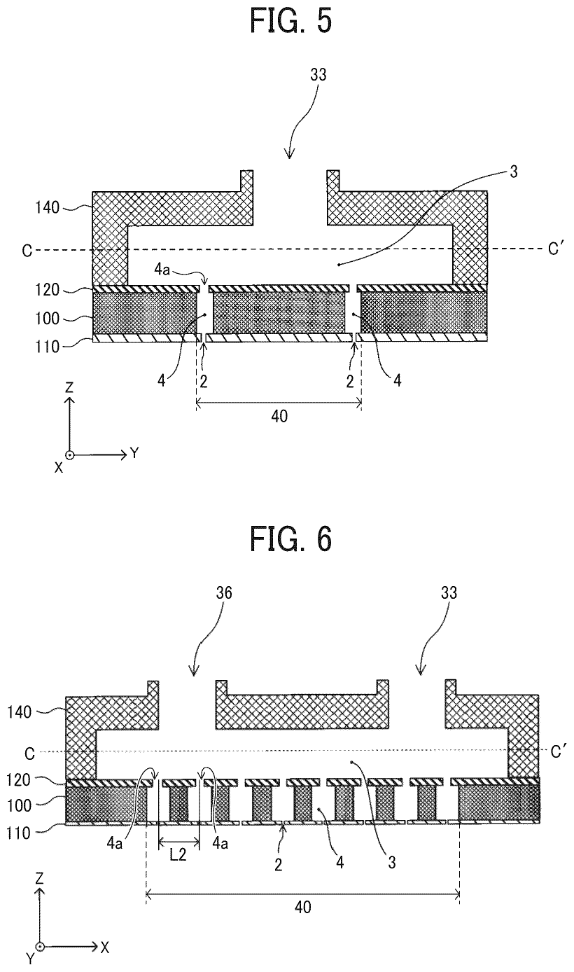

FIG. 5 is a front view schematically illustrating the internal structure of the liquid discharge head 1 according to the present embodiment, and is a cross-sectional view taken along a line A-A′.

FIG. 6 is a side view schematically illustrating the internal structure of the liquid discharge head 1 according to the present embodiment, and is a cross-sectional view taken along a line B-B′.

As illustrated in FIGS. 5 and 6, the liquid discharge head 1 according to the present embodiment includes the nozzle plate 110, the pressure chamber substrate 100, the fluid resistance substrate 120, and the frame 140 disposed in this order.

In the pressure chamber substrate 100, a region where the multiple pressure chambers 4 are disposed is a pressure chamber array 40. The openings 4a on the fluid resistance substrate 120 are opened on an upper surface (a surface facing the common liquid chamber 3) of the pressure chamber array 40, and the common liquid chamber 3 formed on the frame 140 is disposed to face the openings 4a on the fluid resistance substrate 120. In the present embodiment, as an example, a dimension of each of the pressure chambers 4 is 220 [μm], and a width of a partition wall defining each of the pressure chambers 4 is 30 [μm]. As a result, a center-to-center distance L2 (see FIG. 6) between two adjacent ones of the pressure chambers 4 is 250 [μm].

The liquid stored in an external liquid storage is supplied to the liquid discharge head 1 through a liquid supply port 33 of the frame 140. The liquid supplied from the liquid supply port 33 is supplied to the common liquid chamber 3, and is supplied from the common liquid chamber 3 to each of the pressure chambers 4 through each of the openings 4a on the fluid resistance substrate 120. A liquid discharge port 36 is further in communication with the common liquid chamber 3. Some liquid in the liquid in the common liquid chamber 3, which is not supplied to each of the pressure chambers 4 via the openings 4a on the fluid resistance substrate 120 is returned from the liquid discharge port 36 to an external ink storage via an external pump or the like.

Next, a configuration of each of the nozzles, which is a feature of the present embodiment, will now be described herein.

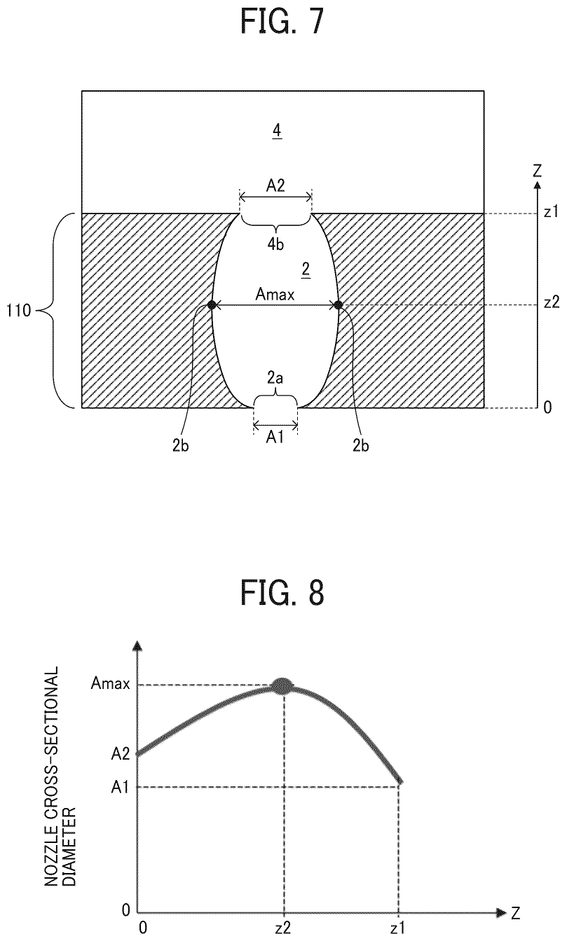

FIG. 7 is an explanatory view schematically illustrating a cross section of the nozzle 2 according to the present embodiment, which is taken in a liquid discharging direction Z;

A cross-sectional shape of the nozzle 2 according to the present embodiment, which is orthogonal to the liquid discharging direction Z, has a substantially circular shape. The nozzle 2 according to the present embodiment includes, at an intermediate position from an inlet 4a (the opening that opens to the pressure chamber 4) to an outlet 2a (an opening that opens to the nozzle surface), one location 2b presenting a maximum value where a cross-sectional area inside the nozzle, which is orthogonal to the liquid discharging direction Z, is greater than an opening area of the outlet 2a.

FIG. 8 is a graph illustrating, in the nozzle 2 according to the present embodiment, an example of a relationship between a distance z from the nozzle surface in the liquid discharging direction Z and a cross-sectional diameter A (hereinafter referred to as a “nozzle cross-sectional diameter”) inside the nozzle.

The nozzle cross-sectional diameter A is a diameter when an internal space of the nozzle 2 is cut along a desired cross section parallel to the nozzle surface (a desired cross section orthogonal to the liquid discharging direction Z). When the distance from the nozzle surface in the liquid discharging direction Z is z (the nozzle surface is z=0), it is possible to express the nozzle cross-sectional diameter A with a function of the distance z from the nozzle surface as illustrated in the graph of FIG. 8. In the present embodiment, the nozzle cross-sectional diameter A continuously changes from the nozzle surface to the pressure chamber 4.

For discharging the liquid at a small amount, in general, it is necessary to reduce the opening area (nozzle cross-sectional diameter A1) of the outlet 2a of the nozzle 2. In an ordinary nozzle in which the nozzle cross-sectional diameter is constant over the nozzle 2 entirely (the nozzle entirely has a straight portion), at this time, as the nozzle cross-sectional diameter A1 of the outlet 2a of the nozzle 2 decreases, an inertance (degree of difficulty of flow of the liquid) of the nozzle also entirely increases. As a result, a disadvantage such as ligament (phenomenon in which a rear end in a discharging direction of the discharged liquid extends like a tail) or satellite (mist generated when the liquid is discharged) is likely to occur.

Formula (1) described below is a calculation equation of an inertance in an annular flow channel. In Formula (1), M is an inertance, ρ is a density of a liquid, l is a length of the flow channel, and d is a diameter of the flow channel.

$$\begin{matrix}[ Math . 1 ] & \\ M = \frac{4 ρ l}{π {d}^{2}} \times 1.45 & ( 1 )\end{matrix}$$

To suppress such a disadvantage as ligament and satellite, reducing an entire inertance of the nozzle is effective. Although, when such a configuration is applied that a tapered portion in which the nozzle cross-sectional diameter increases toward the pressure chamber 4 is provided, similar to a liquid discharge head of a comparative example (for example, a recording head disclosed in Japanese Unexamined Patent Application Publication No. 2011-073245), it is possible to reduce the entire inertance of the nozzle, however, another disadvantage may arise. In particular, a remarkable disadvantage is that air bubbles are likely to be generated in the pressure chambers 4, and, as a result, it is difficult to exert stable discharging performance. This disadvantage remarkably appears in a nozzle-plate-vibration type configuration, similar to the liquid discharge head 1 according to the present embodiment.

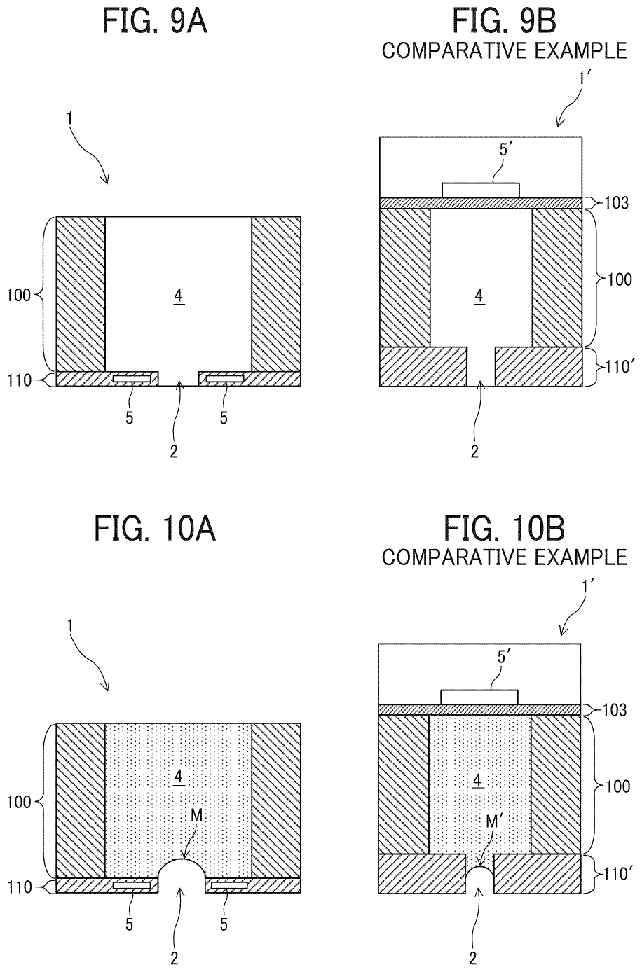

FIGS. 9A and 9B are explanatory views for comparing thicknesses of the nozzle plate 110 and a nozzle plate 110′ between the nozzle-plate-vibration type liquid discharge head 1 and an ordinary liquid discharge head 1′.

Since, as illustrated in FIGS. 9A and 9B, in the nozzle-plate-vibration type liquid discharge head 1, it is necessary to cause the nozzle plate 110 that is the nozzle-forming wall to displace, the nozzle plate 110 is formed to be thinner in thickness than the nozzle plate 110′ of the ordinary liquid discharge head 1′. As an example, while the thickness of the nozzle plate 110 of the nozzle-plate-vibration type is 7 μm, for example, the thickness of the nozzle plate 110′ of the ordinary liquid discharge head is 50 μm, for example. Due to this difference, a length of each of the nozzles 2 (length in the liquid discharging direction Z) formed in the nozzle plate 110 of the nozzle-plate-vibration type is shorter than a length of a nozzle 2′ in the ordinary liquid discharge head.

FIGS. 10A and 10B are explanatory views for comparing a meniscus M and a meniscus M′ between the nozzle-plate-vibration type liquid discharge head 1 and the ordinary liquid discharge head 1′.

In the nozzle-plate-vibration type liquid discharge head 1 and the ordinary liquid discharge head 1′, the meniscus M and the meniscus M′ are formed due to the liquid in the nozzles 2. When the length of the nozzle 2′ is long, similar to the ordinary liquid discharge head 1′, as illustrated in FIG. 10B, the meniscus M′ formed in the nozzle 2′ is accommodated inside the nozzle 2′ and does not protrude to the pressure chamber 4. When the length of the nozzle 2 is short, similar to the nozzle-plate-vibration type liquid discharge head 1, as illustrated in FIG. 10A, however, the meniscus M formed in the nozzle 2 is not accommodated inside the nozzle 2 and protrudes to the pressure chamber 4.

When the meniscus M and a meniscus M′ protrude to the pressure chamber 4, external air is positioned inside the pressure chambers 4, and the external air tends to easily remain as air bubbles in the pressure chambers 4. Specifically, when a restoring force of a meniscus having a shape of being drawn into the pressure chamber 4 is strong, it is possible to cause air positioned in the pressure chamber 4 to be moved toward the space inside the nozzle 2 with a sufficient force, and to be discharged. However, if this restoring force is insufficient to move the air positioned in the pressure chamber 4 toward the space inside the nozzle 2, some of the air remains in the pressure chamber 4 as air bubbles. Since the air bubbles remaining in the pressure chamber 4 act like air dampers, the piezoelectric body element 5 hardly causes appropriate fluctuation of pressure to occur in the pressure chamber 4, possibly changing the discharging performance such as an amount of the liquid to be discharged and a speed of discharging the liquid. As a result, it may be difficult to exert stable discharging performance.

It is possible to estimate a restoring force of a meniscus from a pressure difference that occurs at gas-liquid interfaces of the meniscus. When surface tension is y, a radius of curvature on a long-axis side of a meniscus is R1, and a radius of curvature on a short-axis side of the meniscus is R2, a pressure difference ΔP is acquired from Formula (2) described below. As can be seen from Formula (2), as the radius of curvature R1 and the radius of curvature R2 of the meniscus increase, the pressure difference that occurs at the gas-liquid interfaces of the meniscus decreases, resulting in a small restoring force of the meniscus. When R1=R2, Formula (2) described below is ΔP=2r/R1.

$$\begin{matrix}[ Math . 2 ] & \\ Δ P = γ ( \frac{1}{R 1} + \frac{1}{R 2} ) & ( 2 )\end{matrix}$$

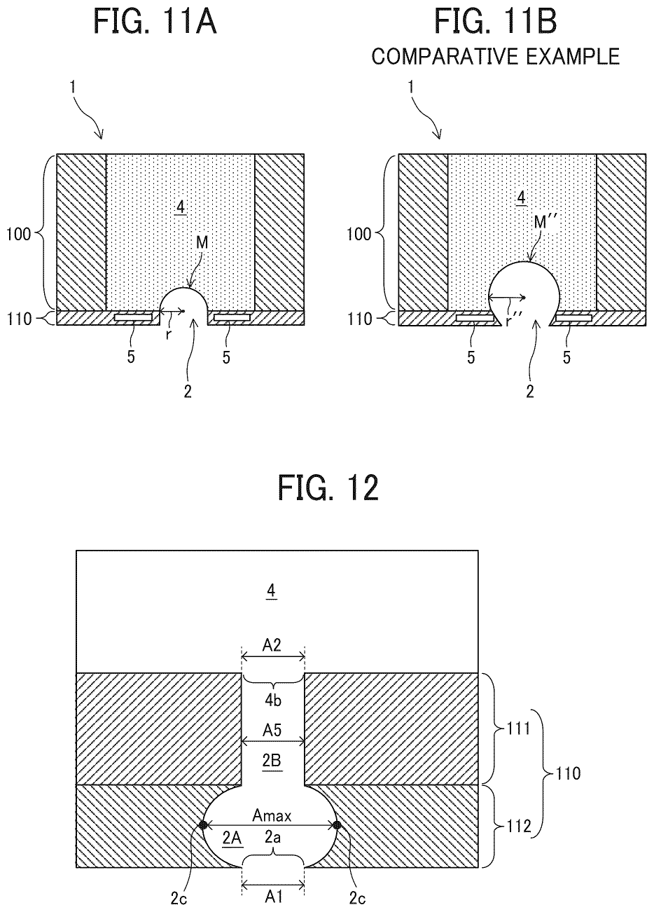

FIGS. 11A and 11B are explanatory views for comparing the meniscus M and the meniscus M″ in nozzle shapes in the nozzle-plate-vibration type liquid discharge head 1, that is, a case where the nozzle entirely has a straight portion and a case where the nozzle entirely has a tapered portion.

As the opening area (nozzle cross-sectional diameter A2) of the inlet 4a of the nozzle 2 that opens to the pressure chamber 4 increases, an amount or size of protrusion of the meniscus M formed in the nozzle 2 toward the pressure chamber increases. In the configuration of the typical liquid discharge head provided with the tapered portion in which the nozzle cross-sectional diameter increases toward the pressure chamber 4, as illustrated in FIGS. 11A and 11B, the opening area (nozzle cross-sectional diameter A2) of the inlet 4a of the nozzle 2 is large, compared with the configuration of the nozzle 2 having the straight portion, even if the opening area (nozzle cross-sectional diameter A1) of the outlet of the nozzle 2 is the same.

In the configuration of the typical liquid discharge head, the amount or size of protrusion of the meniscus M″ toward the pressure chamber 4 increases due to the large opening area (nozzle cross-sectional diameter A2) of the nozzle inlet, and the external air tends to remain as air bubbles in the pressure chamber 4. As a result, a disadvantage caused by air bubbles in the pressure chamber 4 (disadvantage that it is difficult to exert stable discharging performance) becomes remarkable.

In the nozzle shape in the present embodiment, as illustrated in FIG. 7, there is included, at an intermediate position from the inlet 4a to the outlet 2a, the one location 2b presenting a maximum value Amax where the nozzle cross-sectional diameter (cross-sectional area) is greater than the nozzle cross-sectional diameter (opening area) A2 of the outlet 2a. When compared with the ordinary liquid discharge head l′ in which the nozzle has entirely a straight portion, the entire inertance of the nozzle is reduced, as a result of the presence of the nozzle portion (the location 2b presenting the maximum value Amax) presenting the large nozzle cross-sectional diameter, even if the opening area (nozzle cross-sectional diameter A1) of the outlet of the nozzle 2 is the same. Similar to the typical liquid discharge head including the tapered portion, it is possible to suppress such a disadvantage as ligament or satellite described above.

The nozzle cross-sectional diameter (opening area) A2 of the inlet 4a of the nozzle 2 in the present embodiment is smaller than the nozzle cross-sectional diameter (maximum value Amax) at the location 2b, which presents the maximum nozzle cross-sectional diameter. According to the present embodiment, for example, it is possible to make the nozzle cross-sectional diameter A2 of the nozzle inlet 4a smaller than the nozzle cross-sectional diameter in the typical liquid discharge head, even if the maximum value Amax is set to be approximately identical to a value of the nozzle cross-sectional diameter of the nozzle inlet in the typical liquid discharge head for setting the entire inertance of the nozzle to be approximately identical to the inertance in the typical liquid discharge head including the tapered portion. With the liquid discharge head 1 according to the present embodiment, it is possible to reduce the amount or size of protrusion of the meniscus M formed in the nozzle 2 toward the pressure chamber 4, compared with the typical liquid discharge head, and it is possible to suppress a disadvantage caused by air bubbles in the pressure chamber 4 (disadvantage that it is difficult to exert stable discharging performance).

It is possible to consider that an entire inertance of the nozzle is one that is to be acquired by integrating an inertance value corresponding to the nozzle cross-sectional diameter A at a desired position in the liquid discharging direction Z by a nozzle length. Multiple locations (locations presenting the maximum value) where the nozzle cross-sectional diameter becomes maximum may be present at intermediate positions from the inlet 4a to the outlet 2a of the nozzle 2. In this case, however, there is a location where the nozzle cross-sectional diameter (cross-sectional area) presents a minimum value at an intermediate position from the inlet 4a to the outlet 2a of the nozzle 2, and, if an inertance at this portion is too large, the entire inertance of the nozzle increases. The nozzle cross-sectional diameter (cross-sectional area) at the location presenting the minimum value is preferably set to prevent the entire inertance of the nozzle from becoming too large, and, for example, is preferably greater than the nozzle cross-sectional diameter A1 of the nozzle outlet 2a.

However, it should be noted that, when the maximum value Amax of the nozzle cross-sectional diameter is too large, a flow of the liquid in the nozzle may be disturbed, possibly deteriorating discharging efficiency. In the present embodiment, it is possible to appropriately set the nozzle cross-sectional diameter A2 of the nozzle inlet 4a preferably to a value smaller than the maximum value Amax. The nozzle cross-sectional diameter A2 of the nozzle inlet 4a is not necessarily identical to the nozzle cross-sectional diameter A1 of the nozzle outlet 2a.

### First Modification

Next, a modification (hereinafter the present modification will be referred to as “First Modification”) of the nozzle shape in the present embodiment will now be described herein.

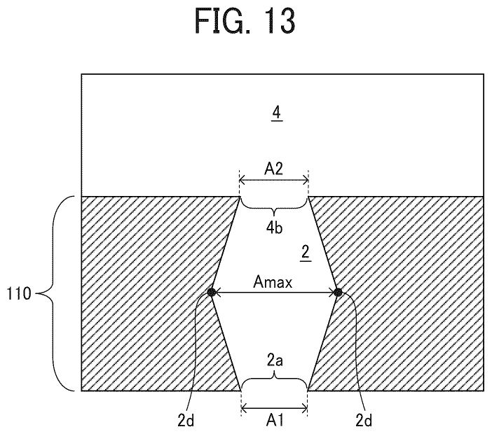

FIG. 12 is an explanatory view schematically illustrating a cross section of the nozzle 2 in the liquid discharge head 1 according to First Modification, which is taken in the liquid discharging direction Z.

In the liquid discharge head 1 according to First Modification, as illustrated in FIG. 12, the nozzle plate 110 has a multilayer structure of multiple layers stacked in the liquid discharging direction Z. Specifically, similar to the embodiment described above, the nozzle plate 110 has a two-layer structure including a layer of the nozzle formation portion 111 and a layer of the liquid-repellent film 112.

In the nozzle 2 in First Modification, a location 2c presenting the maximum value Amax where the nozzle cross-sectional diameter (cross-sectional area) is greater than the nozzle cross-sectional diameter (opening area) A2 of the outlet 2a is provided in a nozzle portion 2A formed in the liquid-repellent film 112. A nozzle portion 2B formed in the nozzle formation portion 111 includes a straight portion in which a nozzle cross-sectional diameter (cross-sectional area) is constant.

In general, when the nozzle plate 110 has a multilayer structure, it may be difficult to form the location 2c presenting the maximum value Amax as described above depending on a material, a processing method, and the like.

For example, in a case of First Modification, it is relatively easy to form the location 2c presenting the maximum value Amax as described above in the liquid-repellent film 112 (to form the location to allow the nozzle inner wall shape of the cross section taken in the liquid discharging direction Z to be a curved line, as illustrated in FIGS. 7 and 12, for example). However, it is difficult to form the location 2c presenting the maximum value Amax as described above in the nozzle formation portion 111.

In First Modification, the nozzle formation portion 111 where it is difficult to form the location 2c presenting the maximum value Amax has the straight portion in which the nozzle cross-sectional diameter is constant. It is possible to suppress a disadvantage such as ligament or satellite by reducing the entire inertance of the nozzle while lowering a degree of difficulty in forming the nozzles 2 (degree of difficulty in processing nozzles) and to suppress a disadvantage caused by air bubbles in the pressure chamber.

However, it should be noted that the configuration in which the nozzle cross-sectional diameter continuously changes over the nozzle entirely, similar to the embodiment described above (as illustrated in FIG. 7), presents a high effect of reducing the entire inertance of the nozzle and a high effect of suppressing such a disadvantage as ligament or satellite, similar to the present modification, compared with the configuration in which only the nozzle cross-sectional diameter of one portion of the nozzle continuously changes (configuration in which the other portion of the nozzle has a straight portion).

### Second Modification

Next, another modification (hereinafter the present modification will be referred to as “Second Modification”) of the nozzle shape in the present embodiment will now be described herein.

FIG. 13 is an explanatory view schematically illustrating a cross section of the nozzle 2 in the liquid discharge head 1 according to Second Modification, which is taken in the liquid discharging direction Z.

As for the location 2c presenting the maximum value Amax where the nozzle cross-sectional diameter (cross-sectional area) is greater than the nozzle cross-sectional diameter (opening area) A2 of the outlet 2a, in the liquid discharge head 1 according to the embodiment or First Modification described above, the nozzle inner wall shape (or an inner-wall profile) of the cross section taken in the liquid discharging direction Z is a curved line as illustrated in FIGS. 7 and 12. As for a location 2d presenting the maximum value Amax where the nozzle cross-sectional diameter (cross-sectional area) is greater than the nozzle cross-sectional diameter (opening area) A2 of the outlet 2a, in the liquid discharge head 1 according to Second Modification, as illustrated in FIG. 13, on the other hand, the nozzle inner wall shape of the cross section taken in the liquid discharging direction Z is a polygonal line.

In the case where the nozzle inner wall shape of the cross section taken in the liquid discharging direction Z is a polygonal line, similar to Second Modification, an integrated value of the nozzle cross-sectional diameter over the nozzle length is smaller than an integrated value in a case where the nozzle inner wall shape is a curved line. Therefore, the effect of reducing the entire inertance of the nozzle is small, and the effect of suppressing such a disadvantage as ligament or satellite is also small. On the other hand, it is possible to easily straighten the flow of the liquid in the nozzle, making it possible to increase the discharging efficiency.

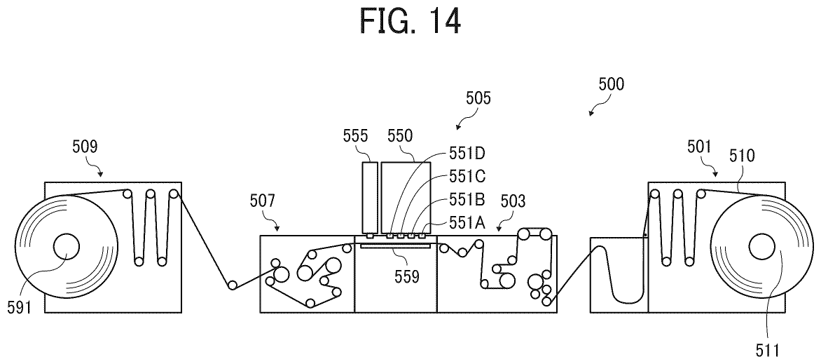

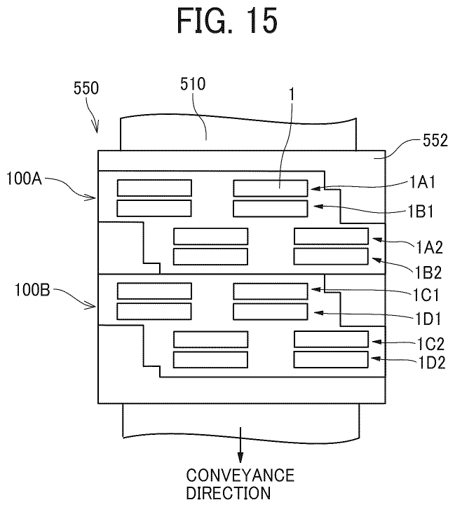

Next, an example of a liquid discharge apparatus according to the present invention will now be described herein with reference to FIGS. 14 and 15.

FIG. 14 is an outline explanatory view of a printer that is an inkjet recording apparatus that is an image forming apparatus serving as the liquid discharge apparatus according to the present embodiment.

FIG. 15 is a plan explanatory view of an example of a head unit of the printer according to the present embodiment.

A printer 500, which is a liquid discharge apparatus, includes a feeder 501 that carries in a continuous medium 510, and a guide conveyor 503 that guides and conveys the continuous medium 510 carried in from the feeder 501 to a printing unit 505. The printer 500 further includes the printing unit 505, a dryer 507, and a carrier 509. The printing unit 505 discharges liquid onto the continuous medium 510 to form an image. The dryer 507 dries the continuous medium 510. The carrier 509 discharges the continuous medium 510.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. In the printing unit 505, the continuous medium 510 is conveyed on a conveyance guide member 559 while facing the head unit 550, and is formed with an image with the liquid that the head unit 550 discharges.

In the printer 500 according to the present embodiment, the head unit 550 includes two head modules that are a head module 100A and a head module 100B according to the present embodiment described above on a common base member 552.

The liquid in a certain color is discharged from a head array 1A1 and a head array 1A2 in the head module 100A when an arrangement direction of the liquid discharge heads 1 in a direction orthogonal to a conveyance direction of the head module 100A and the head module 100B is set as a head array direction. In a similar manner, the liquid in a desired color is discharged from a pair of a head array 1B1 and a head array 1B2 in the head module 100A and a pair of a head array 1C1 and a head array 1C2 and a pair of a head array 1D1 and a head array 1D2 in the head module 100B.

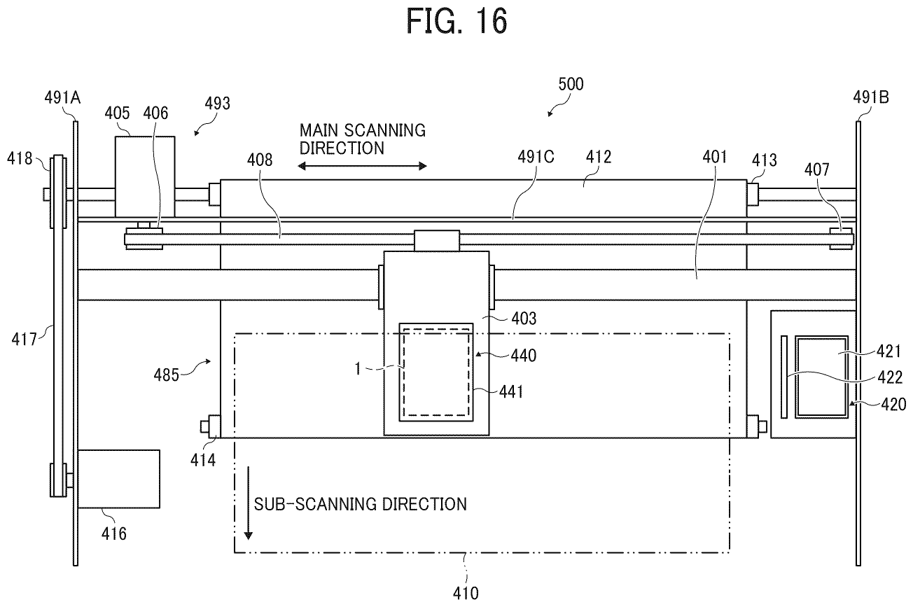

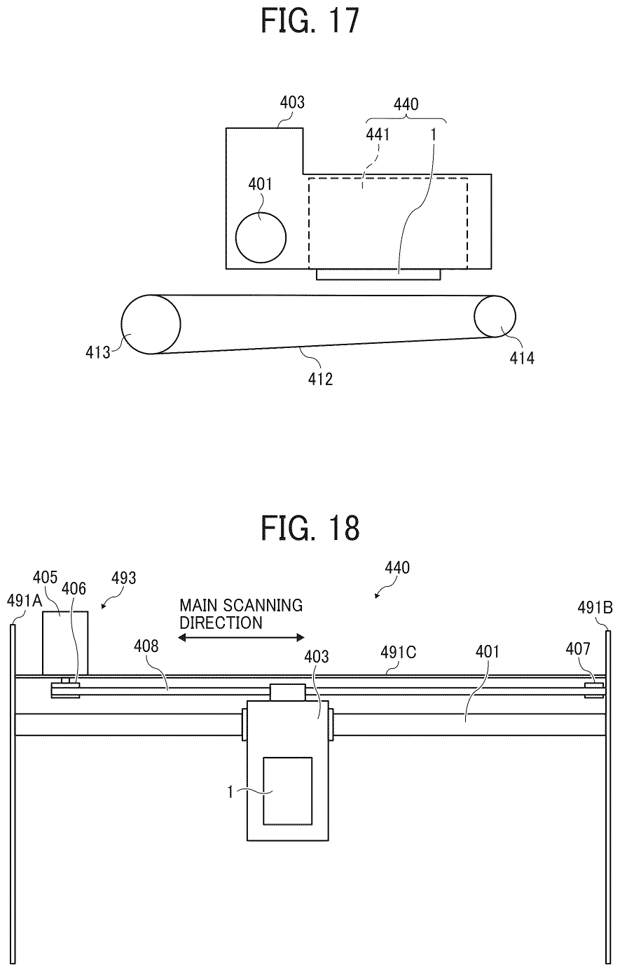

Next, another example of a printer serving as the liquid discharge apparatus according to the present invention will now be described herein with reference to FIGS. 16 and 17.

FIG. 16 is a plan explanatory view of a main portion of the printer according to the present example.

FIG. 17 is a side explanatory view of the main portion of the printer according to the present example.

The printer 500 according to the present example is a serial type apparatus, and a carriage 403 is reciprocally moved in a main scanning direction by a main-scanning movement mechanism 493. The main-scanning movement mechanism 493 includes a guide member 401, a main-scanning motor 405, a timing belt 408, and the like. The guide member 401 is bridged between a side plate 491A and a side plate 491B on left and right for moveably holding the carriage 403.

The main-scanning motor 405 reciprocally moves the carriage 403 in the main scanning direction via the timing belt 408 bridged between a drive pulley 406 and a driven pulley 407.

The carriage 403 includes a liquid discharge unit 440 in which the liquid discharge head 1 according to the present invention and a head tank 441 are integrated with each other. The liquid discharge head 1 discharges color liquids of, for example, yellow (Y), cyan (C), magenta (M), and black (K).

The liquid discharge head 1 includes a nozzle array including multiple nozzles, which is disposed in a sub-scanning direction orthogonal to the main scanning direction, with its discharging direction oriented downward. The liquid discharge head 1 is coupled to a liquid circulation apparatus, and the liquids in desired colors are circulated and supplied.

The printer 500 includes a conveyance mechanism 495 for conveying a sheet 410. The conveyance mechanism 495 includes a conveyance belt 412 serving as a conveyor and a sub-scanning motor 416 for driving the conveyance belt 412. The conveyance belt 412 attracts and conveys the sheet 410 to a position facing the liquid discharge head 1. The conveyance belt 412 is an endless belt stretched between a conveyance roller 413 and a tension roller 414. Attraction may be implemented using electrostatic attraction, air suction, or the like. The conveyance belt 412 cyclically rotates in the sub-scanning direction as the conveyance roller 413 is rotationally driven by the sub-scanning motor 416 via the timing belt 417 and the timing pulley 418.

On one side in the main scanning direction of the carriage 403, a maintenance-and-recovery mechanism 420 for maintaining and recovering the liquid discharge head 1 is disposed on a lateral side of the conveyance belt 412. The maintenance-and-recovery mechanism 420 includes, for example, a cap member 421 for capping the nozzle surface of the liquid discharge head 1 and a wiper member 422 for wiping the nozzle surface. The main-scanning movement mechanism 493, the maintenance-and-recovery mechanism 420, and the conveyance mechanism 495 are mounted on a housing including a side plate 491A and a side plate 491B and a back plate 491C.

In the printer 500 configured as described above, the sheet 410 is conveyed on and attracted to the conveyance belt 412 and is conveyed in the sub-scanning direction through a cyclic rotation of the conveyance belt 412. The liquid discharge head 1 is driven in response to an image signal while the carriage 403 is moved in the main scanning direction, and the liquids are discharged onto the sheet 410 not in motion for forming an image.

Next, another example of the liquid discharge unit according to the present invention will now be described herein with reference to FIG. 18.

FIG. 18 is a plan explanatory view of a main portion of the liquid discharge unit according to the present example.

The liquid discharge unit 440 includes the housing including the side plate 491A and the side plate 491B and the back plate 491C, the main-scanning movement mechanism 493, the carriage 403, and the liquid discharge head 1 among members forming the liquid discharge apparatus.

In the liquid discharge unit 440, the maintenance-and-recovery mechanism 420 described above may be mounted on, for example, the side plate 491B.

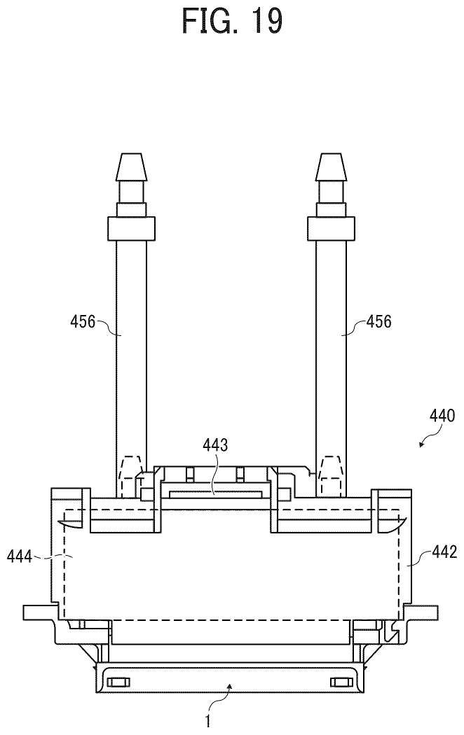

Next, still another example of the liquid discharge unit according to the present invention will now be described herein with reference to FIG. 19.

FIG. 19 is a front explanatory view of the liquid discharge unit according to the present example.

The liquid discharge unit 440 includes the liquid discharge head 1 to which a flow channel portion 444 is attached and a tube 456 coupled to the flow channel portion 444.

The flow channel portion 444 is disposed inside a cover 442. Instead of the flow channel portion 444, the head tank 441 may be included. A connector 443 electrically coupled to the liquid discharge head 1 is provided on an upper portion of the flow channel portion 444.

In the present application, the liquid to be discharged is not limited to particular liquid as long as the liquid presents viscosity or surface tension at a level allowing the liquid to be discharged from a head. However, preferably, the viscosity of the liquid is not greater than 30 mPa·s under an ordinary temperature and ordinary pressure or under heating or cooling. More specifically, examples of the liquid include a solution, a suspension, and an emulsion that contain, for example, a solvent, such as water or an organic solvent, a colorant, such as dye or pigment, a functional material, such as a polymerizable compound, a resin, or a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The liquid to be discharged may be one that includes a metal material such as solder or a material that is solid at a room temperature, such as wax ink, and that is heated and melted, and discharged from the nozzle. The liquid to be discharged may be one that includes a liquid that presents high viscosity at a room temperature, such as ultraviolet (UV) ink, and that is heated to lower the viscosity, and discharged from the nozzle. In this case, by providing a heating device such as a heater on the frame 140 or the pressure chamber substrate 100, a material to be discharged, which is present in the pressure chamber 4, can be brought into a molten state or a low viscosity state, making it possible to satisfactorily discharge the liquid from the nozzle. Aluminum nitride (AlN) containing at least one material of scandium, yttrium, titanium, magnesium, hafnium, zirconium, tin, chromium, and boron may be preferably used as an electrostrictive material of a piezoelectric body in this case. Specifically, aluminum in aluminum nitride is partially replaced with at least one of the materials described above. The aluminum nitride can contain at least one of the materials described above. It is possible to enhance piezoelectric performance by using, as the piezoelectric material, aluminum nitride containing aluminum partially replaced with at least one of the materials described above. The electrostrictive material of the piezoelectric body is not limited to aluminum nitride, and may be a desired electrostrictive material having high heat resistance, which does not change in displacement amount even in a high-temperature environment.

The “liquid discharge unit” is an assembly of parts relating to liquid discharge. The term “liquid discharge unit” represents a structure including the liquid discharge head and a functional part(s) or unit(s) combined to the head to form a single unit. For example, the “liquid discharge unit” includes a combination of the liquid discharge head with at least one of a head tank, a carriage, a supply mechanism, a maintenance-and-recovery mechanism, a main-scanning movement mechanism, and a liquid circulation apparatus.

Examples of the “single unit” include a combination in which the liquid discharge head and one or more functional parts and units are secured to each other through, e.g., fastening, bonding, or engaging, and a combination in which one of the liquid discharge head and the functional parts and units is movably held by another. The liquid discharge head may be detachably attached to the functional part(s) or unit(s) each other.

For example, the liquid discharge head and the head tank may form the liquid discharge unit as a single unit. The liquid discharge head and the head tank may be coupled with a tube or the like to serve as a single unit. A unit including a filter may be added at a position between the head tank and the liquid discharge head of the liquid discharge unit.

The liquid discharge head and the carriage may form the liquid discharge unit as a single unit.

The liquid discharge unit includes the liquid discharge head movably held by a guide member that forms part of a scanning movement mechanism to form the liquid discharge head and the main scan moving unit as a single unit. There is one that the liquid discharge head, the carriage, and the main-scanning movement mechanism are integrated to form a single unit.

A cap member that forms part of the maintenance-and-recovery mechanism may be secured to the carriage to which the liquid discharge head is mounted to allow the liquid discharge head, the carriage, and the maintenance-and-recovery mechanism to form a single unit to form a liquid discharge unit.

The liquid discharge unit includes tubes coupled to the head tank or the liquid discharge head to which a flow channel portion is mounted to allow the liquid discharge head and the supply mechanism to form a single unit. The liquid in a liquid reservoir source is supplied to the liquid discharge head through the tubes.

The main-scanning movement mechanism may include a guide member itself. The supply mechanism may include a tube itself or a loading unit itself.

A liquid discharge head includes a pressure chamber (4) and a nozzle plate (10). The pressure chamber (4) stores liquid. The nozzle plate (110) has a nozzle (2) communicating with the pressure chamber (4). The nozzle plate (110) includes an actuator (5) in the nozzle plate (110) to displace the nozzle plate (110) to discharge the liquid in the pressure chamber (4) from the nozzle (2) in a discharge direction; and an outlet (2a) having a first cross-sectional area (A1) in a plane orthogonal to the discharge direction; an inlet (4b) having a second cross-sectional area (A2) in the plane; and an intermediate portion (2b) between the outlet (2a) and the inlet (4b) in the discharge direction. The intermediate portion (2b) has a maximum cross-sectional area (Amax) larger than the first cross-sectional area (A1) of the outlet (2a) and the second cross-sectional area (A2) of the inlet (4b) in the plane.

The intermediate portion has the maximum cross-sectional area at an intermediate position (2b) between the outlet (2a) and the inlet (4b) in the discharge direction. The intermediate portion has a third cross-sectional area in the plane that continuously changes from the outlet (2a) to the inlet (4a) through the intermediate position (2b), and the third cross-sectional area is greater than the first cross-sectional area throughout a region between the inlet and the outlet in the discharge direction.

The liquid discharge head further includes a pressure chamber substrate (100) on the nozzle plate (100), the pressure chamber including the pressure chamber (4). The nozzle plate defining a part of a wall of the pressure chamber. The nozzle plate includes the actuator including an annular actuator surrounding the nozzles (2).

The first cross-sectional area (A1) of the outlet (4) is smaller than the second cross-sectional area (A2) of the inlet (4).

The nozzle plate (110) includes a first layer (111) having a first nozzle; and a second layer on the first layer, the second layer having a second nozzle continuously communicating with the first nozzle. The first nozzle has a fourth cross-sectional area in the plane. The fourth cross-sectional area is constant in the discharge direction. The second layer has the outlet (2a); the inlet (4b); and the intermediate portion (2b).

The nozzle has a continuously curved cross-sectional profile in the intermediate position (2b) in a cross-section along the discharge direction.

The nozzle has a polygonal cross-sectional profile in the intermediate position (2b) in a cross-section along the discharge direction.

The intermediate portion has multiple maximum cross-sectional areas including the maximum cross-sectional area, at multiple intermediate positions (2b) between the outlet (2a) and the inlet (4b) in the discharge direction, respectively.

A liquid discharge apparatus includes the liquid discharge head (1).

Note that, while the “liquid discharge unit” is described as a combination with the liquid discharge head in here, the “liquid discharge unit” includes a head module including the liquid discharge head described above and a head unit in which the functional components and mechanisms described above are combined to form a single unit.

The “liquid discharge apparatus” includes an apparatus that includes the liquid discharge head, the liquid discharge unit, the head module, the head unit, and the like, and discharges the liquid by driving the liquid discharge head. The liquid discharge apparatus includes an apparatus capable of discharging the liquid to a material to which the liquid can adhere or an apparatus that discharges the liquid toward gas or into liquid.

The “liquid discharge apparatus” may further include devices relating to feeding, conveying, and ejecting of a material onto which the liquid can adhere and also include a pretreatment device and an aftertreatment device.

The “liquid discharge apparatus” may be, for example, an image forming apparatus that is an apparatus for forming an image on a sheet by discharging ink, or a three-dimensional fabrication apparatus that discharges a fabrication liquid to a powder layer in which a powder material is formed in layers to form a three-dimensional fabrication object.

The “liquid discharge apparatus” is not limited to an apparatus that discharges the liquid to visualize meaningful images such as letters or figures. For example, the liquid discharge apparatus may be an apparatus that forms patterns having no meaning or an apparatus that fabricates three-dimensional images.

The term “medium onto which liquid can adhere” described above represents a medium on which the liquid is at least temporarily adhered, a medium on which the liquid is adhered and fixed, or a medium into which the liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric body element, and a medium such as layered powder, an organ model, or a testing cell. The “medium onto which liquid can adhere” includes any mediums to which the liquid adheres, unless otherwise specified.

Examples of the “material onto which liquid can adhere” include any materials to which the liquid can adhere even temporarily, such as paper, thread, fiber, fabric, leather, metal, plastic, glass, wood, and ceramic.

The “liquid discharge apparatus” may be an apparatus that allows the liquid discharge head and a material on which the liquid can adhere to relatively move. However, the liquid discharge apparatus is not limited to such an apparatus. For example, the liquid discharge apparatus may be a serial type apparatus that moves the liquid discharge head or a line type apparatus that does not move the liquid discharge head.

Examples of the “liquid discharge apparatus” further include a treatment liquid coating apparatus that discharges treatment liquid to a sheet to coat a surface of the sheet with the treatment liquid for reforming the surface of the sheet. There is an injection granulation apparatus for spraying a composition liquid in which raw materials are dispersed in a solution through a nozzle to granulate fine particles of the raw material.

The terms “image formation”, “recording”, “printing”, “image printing”, and “fabricating” used herein may be used synonymously with each other.

The configurations described above are examples, and aspects of the present disclosure provide respective effects as follows.

### First Aspect

According to a first aspect, a liquid discharge head 1 includes: a nozzle 2 that discharges liquid; a pressure chamber 4 that is in communication with the nozzle; and an actuator (for example, the piezoelectric body element 5) that causes fluctuation of pressure to occur in the pressure chamber, the liquid discharge head 1 driving the actuator to discharge the liquid in the pressure chamber from the outlet 2a of the nozzle, the nozzle including, at an intermediate position from the inlet 4a that opens to the pressure chamber to the outlet 2a, at least one of locations 2b, 2c, and 2d presenting the maximum value Amax where a cross-sectional area (for example, the nozzle cross-sectional diameter) inside the nozzle, the cross-sectional area being orthogonal to the liquid discharging direction Z, is greater than an opening area (for example, the cross-sectional diameter A1 of the nozzle outlet) of the outlet.

When the opening area of the nozzle outlet is reduced for discharging the liquid at a small amount, in an ordinary nozzle in which the cross-sectional area (hereinafter also simply referred to as the “cross-sectional area”) inside the nozzle, which is orthogonal to the liquid discharging direction, is constant over the nozzle entirely (the nozzle has entirely a straight portion), an inertance (a degree of difficulty of flow of the liquid) of the nozzle also entirely increases. As a result, a disadvantage such as ligament (phenomenon in which a rear end in a discharging direction of the discharged liquid extends like a tail) or satellite (mist generated when the liquid is discharged) is likely to occur.

On the other hand, Japanese Unexamined Patent Application Publication No. 2011-073245 discloses a recording head (liquid discharge head) that vibrates a vibration plate forming a wall portion facing a nozzle plate (nozzle-forming wall or simply as a nozzle wall) of a pressure generation chamber (pressure chamber) by a piezoelectric vibrator (actuator) to fluctuate pressure in the pressure chamber. In this recording head, the nozzle portion on the pressure generation chamber side from the nozzle outlet from which the liquid is discharged has a straight portion having a constant cross-sectional area inside the nozzle, which is orthogonal to the liquid discharging direction. The nozzle portion to the pressure generation chamber continuous from the straight portion is a tapered portion in which the cross-sectional area increases toward the pressure generation chamber.

In the recording head (liquid discharge head) disclosed in Japanese Unexamined Patent Application Publication No. 2011-073245, as described above, the nozzle portion to the pressure generation chamber continuous from the straight portion on the nozzle outlet side is a tapered portion in which the cross-sectional area inside the nozzle increases toward the pressure generation chamber side. In the typical liquid discharge head, compared with an ordinary nozzle in which the nozzle has entirely a straight portion, the inertance of the nozzle is entirely reduced, as a result of the presence of the nozzle portion having a wide cross-sectional area inside the nozzle. It is possible to suppress such a disadvantage as ligament or satellite described above.

However, in such a liquid discharge head, the opening area of the nozzle inlet is enlarged more than the opening area in the ordinary nozzle, and this enlargement causes various disadvantages. In particular, a remarkable disadvantage is that air bubbles are likely to be generated in the pressure chamber, and, as a result, it is difficult to exert stable discharging performance. This disadvantage remarkably appears when the thickness of the nozzle-forming wall is thin, similar to a nozzle-plate-vibration type liquid discharge head in which an actuator is provided on a nozzle-forming wall of a pressure chamber and the nozzle-forming wall is displaced to fluctuate pressure in the pressure chamber for discharging the liquid.

Specifically, in the nozzle-plate-vibration type liquid discharge head, the nozzle-forming wall is formed thin for displacing the nozzle-forming wall, and, as a result, a length (length in the liquid discharging direction) of the nozzle formed on the nozzle-forming wall is short. In this case, a meniscus formed in the nozzle is not accommodated inside the nozzle, and is formed to protrude from the nozzle inlet toward the pressure chamber, and external air may be positioned inside the pressure chamber. The external air tends to remain as air bubbles in the pressure chamber. Since the air bubbles remaining in the pressure chamber act like air dampers, the actuator hardly causes appropriate pressure fluctuation to occur in the pressure chamber, and the discharging performance such as an amount of the liquid to be discharged and a speed of discharging the liquid changes, making it difficult to exert stable discharging performance. At this time, as the opening area of the nozzle inlet that opens to the pressure chamber expands, the amount or size of protrusion of the meniscus formed in the nozzle toward the pressure chamber increases. When the opening area of the nozzle inlet is expanded larger than the opening area of an ordinary nozzle, similar to the typical liquid discharge head, the amount or size of protrusion of the meniscus toward the pressure chamber increases, and the external air tends to remain as air bubbles in the pressure chamber. As a result, a disadvantage caused by air bubbles in the pressure chamber (disadvantage that stable discharging performance is hardly exerted) becomes remarkable.

In the present aspect, at least one location presenting the maximum value where the cross-sectional area inside the nozzle, which is orthogonal to the liquid discharging direction, is greater than the opening area of the outlet is provided at an intermediate position in the nozzle from the inlet (the inlet of the nozzle that opens to the pressure chamber) to the outlet (the outlet of the nozzle from which the liquid is discharged). Compared with an ordinary nozzle in which a straight portion having a constant cross-sectional area inside the nozzle, which is orthogonal to the liquid discharging direction, is formed across the nozzle entirely, it is possible to reduce the entire inertance of the nozzle, as a result of the presence of the nozzle portion (location presenting the maximum value) having a wide cross-sectional area inside the nozzle. As a result, it is possible to suppress such a disadvantage as ligament or satellite described above.

According to the present aspect, it is possible to make the opening area of the nozzle inlet smaller than the cross-sectional area at the location presenting the maximum value. Compared with the typical liquid discharge head including a tapered portion in which the cross-sectional area expands to the pressure generation chamber (nozzle inlet), for example, even when the cross-sectional area at the location presenting the maximum value is set to be approximately identical to the opening area of the nozzle inlet in the typical liquid discharge head for acquiring substantially an identical entire inertance of the nozzle, it is possible to reduce the opening area of the nozzle inlet. It is possible to suppress a disadvantage caused by air bubbles in the pressure chamber (disadvantage that it is difficult to exert stable discharging performance), compared with the typical liquid discharge head.

### Second Aspect

According to a second aspect, in the liquid discharge head of the first aspect, the nozzle does not include, at an intermediate position from the inlet 4a that opens to the pressure chamber to the outlet 2a, a location where a cross-sectional area inside the nozzle, the cross-sectional area being orthogonal to the liquid discharging direction Z, presents a minimum value.

It is easy to reduce the entire inertance of the nozzle, and it is easy to suppress such a disadvantage as ligament or satellite described above.

### Third Aspect

According to a third aspect, in the liquid discharge head of the first aspect, the actuator is provided on a nozzle-forming wall (for example, the nozzle plate 110 and the nozzle plate 110′) of the pressure chamber, the nozzle-forming wall being formed with the nozzle.

It is possible to suppress a disadvantage in the nozzle-plate-vibration type liquid discharge head in which the disadvantage that air bubbles are easily generated in the pressure chamber and stable discharging performance is hardly exerted is remarkable.

### Fourth Aspect

According to a fourth aspect, in the liquid discharge head of the third aspect, the at least one location includes a location presenting the maximum value where the cross-sectional area is greater than an opening area of the inlet.

Since the opening area of the nozzle inlet is smaller than the cross-sectional area at the location presenting the maximum value, it is possible to reduce the opening area of the nozzle inlet, compared with a typical liquid discharge head including a tapered portion, for example, even when the cross-sectional area of the location presenting the maximum value is set to be approximately identical to the opening area of the nozzle inlet in the typical liquid discharge head for acquiring an inertance equivalent to an inertance of the nozzle entirely. It is possible to suppress a disadvantage caused by air bubbles in the pressure chamber (disadvantage that it is difficult to exert stable discharging performance), compared with the typical liquid discharge head.

### Fifth Aspect

According to a fifth aspect, in the liquid discharge head of the third aspect or the fourth aspect, the nozzle-forming wall has a multilayer structure of multiple layers (for example, the layer of the nozzle formation portion 111 and the layer of the liquid-repellent film 112) stacked in the liquid discharging direction Z, the at least one location is formed in one or more layers in the multiple layers (for example, the layer of the liquid-repellent film 112), and a cross-sectional area inside the nozzle, the cross-sectional area being orthogonal to the liquid discharging direction, in other remaining layers in the multiple layers (for example, the layer of the nozzle formation portion 111) is constant.

It is possible to suppress such a disadvantage as ligament or satellite by reducing the entire inertance of the nozzle while lowering a degree of difficulty in forming nozzles (degree of difficulty in processing nozzles) and to suppress the disadvantage caused by air bubbles in the pressure chamber.

### Sixth Aspect

According to a sixth aspect, in the liquid discharge head of any one of the first aspect to the fifth aspect, in at least a portion in the liquid discharging direction in the nozzle, the portion including the at least one location, a nozzle inner wall shape of a cross section taken in the liquid discharging direction is a curved line.

Compared with the configuration in which the shape of the inner wall of the nozzle is a polygonal line, it is possible to acquire a high effect of reducing an inertance, and it is possible to enhance an effect of suppressing such a disadvantage as ligament or satellite.

### Seventh Aspect

According to a seventh aspect, in the liquid discharge head of the first aspect to the fifth aspect, in at least a portion in the liquid discharging direction in the nozzle, the portion including the at least one location, a nozzle inner wall shape of a cross section taken in the liquid discharging direction is a polygonal line.

Compared with the configuration in which the shape of the inner wall of the nozzle is a curved line, it is possible to easily straighten the flow of the liquid in the nozzle, making it possible to increase the discharging efficiency.

### Eighth Aspect

According to an eighth aspect, a liquid discharge apparatus includes the liquid discharge head of any one of the first aspect to the seventh aspect.

It is possible to provide a liquid discharge apparatus capable of suppressing a disadvantage caused by air bubbles remaining in the pressure chamber while suppressing such a disadvantage as ligament or satellite.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a pressure chamber to store liquid; and
a nozzle plate having a nozzle communicating with the pressure chamber,
the nozzle plate including:
an actuator in the nozzle plate to displace the nozzle plate to discharge the liquid in the pressure chamber from the nozzle in a discharge direction;
an outlet having a first cross-sectional area in a plane orthogonal to the discharge direction;
an inlet having a second cross-sectional area in the plane; and
an intermediate portion between the outlet and the inlet in the discharge direction,
the intermediate portion having a maximum cross-sectional area larger than the first cross-sectional area of the outlet and the second cross-sectional area of the inlet in the plane.

2. The liquid discharge head according to claim 1, wherein:
the intermediate portion has the maximum cross-sectional area at an intermediate position between the outlet and the inlet in the discharge direction,
the intermediate portion has a third cross-sectional area in the plane that continuously changes from the outlet to the inlet through the intermediate position, and
the third cross-sectional area is greater than the first cross-sectional area throughout a region between the inlet and the outlet in the discharge direction.

3. The liquid discharge head according to claim 1, further comprising:
a pressure chamber substrate on the nozzle plate, the pressure chamber including the pressure chamber,
wherein the nozzle plate defining a part of a wall of the pressure chamber, and
the nozzle plate includes the actuator including an annular actuator surrounding the nozzles.

4. The liquid discharge head according to claim 3, wherein:
the first cross-sectional area of the outlet is smaller than the second cross-sectional area of the inlet.

5. The liquid discharge head according to claim 1, wherein:
the nozzle plate includes:
a first layer having a first nozzle; and
a second layer on the first layer, the second layer having a second nozzle continuously communicating with the first nozzle,
the first nozzle has a fourth cross-sectional area in the plane,
the fourth cross-sectional area constant in the discharge direction,
the second layer has:
the outlet;
the inlet; and
the intermediate portion.

6. The liquid discharge head according to claim 2, wherein:
the nozzle has a continuously curved cross-sectional profile in the intermediate position in a cross-section along the discharge direction.

7. The liquid discharge head according to claim 2, wherein:
the nozzle has a polygonal cross-sectional profile in the intermediate position in a cross-section along the discharge direction.

8. The liquid discharge head according to claim 2, wherein:
the intermediate portion has multiple maximum cross-sectional areas including the maximum cross-sectional area,
at multiple intermediate positions between the outlet and the inlet in the discharge direction, respectively.

9. A liquid discharge apparatus comprising
the liquid discharge head according to claim 1.
